(19) United States
(12) Patent Application Publication
(10) Pub. No.: US 2019/0251812 A1
(43) Pub. Date: Aug. 15, 2019

(54) PROPERTY PROTECTION SYSTEM AND METHOD OF USE

(71) Applicant: Jason S. Choi, Arlington, TX (US)

(72) Inventor: Jason S. Choi, Arlington, TX (US)

(21) Appl. No.: 16/271,861

(22) Filed: Feb. 10, 2019

Related U.S. Application Data
(60) Provisional application No. 62/628,997, filed on Feb. 10, 2018.

(51) Int. Cl. G08B 13/22; G08B 3/10

(52) U.S. Cl. CPC G08B 13/22; G08B 3/10

(57) ABSTRACT

A property protection system alerts a person if an item such as a wallet or billfold has been removed from their person. An alarm device configured to appear like a credit card in shape and size contains a motion sensor and a speaker so that when the item is moved the speaker emits a sound. The alarm can be silenced by a button in the preferred embodiment. The system also incorporates the use of wireless transmitters/receivers and personal devices such as cellular phones or smart phones to control the alarm device.

### BACKGROUND

### 1. Field of the Invention

The present invention relates generally to anti-theft systems, and more specifically, to a personal anti-theft system for determining if a personal item has been removed from a person and sounding an alarm.

### 2. Description of Related Art

Anti-theft systems are well known in the art and are effective means to provide deterrents both active and passive for the purpose of preventing removal of property from its owner. For example, FIG. 1 depicts a conventional anti-loss wallet device101 having a wallet 103 attached to a belt loop 105 of a pair of pants 107 via a chain and latch 109. During use, the wallet is placed in a pocket 111 and the chain 109 keeps the wallet 103 within its length of the pants 107.

One of the problems commonly associated with device 101 is its limited use. For example, the chain and latch 109 restrict the range of motion for the user along with preventing its theft, this causes restriction to the user and potential damage to the pants 107 if the loop 105 is broken by the latch 109.

Accordingly, although great strides have been made in the area of anti-loss wallet devices, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a common anti-loss wallet device;

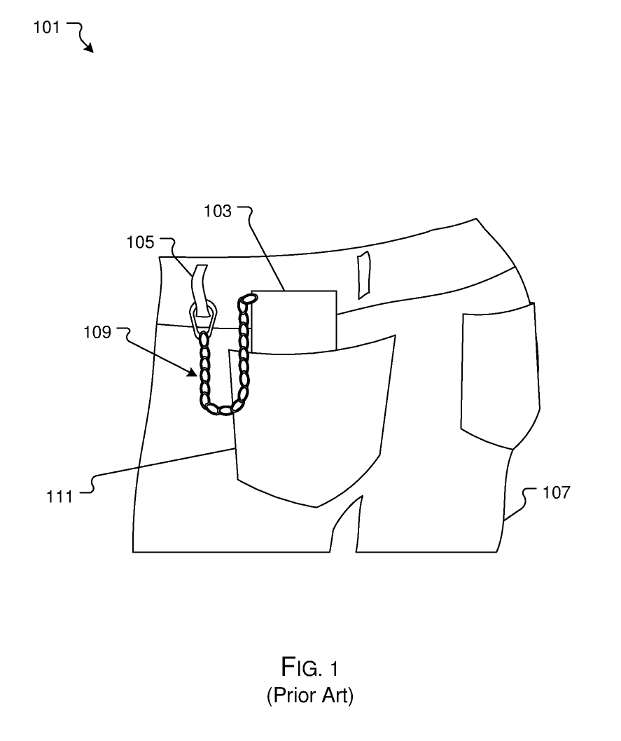

FIG. 2 is a front view of a property protection system in accordance with a preferred embodiment of the present application; and

FIG. 3 is a simplified schematic of the alarm device of FIG. 2;

FIG. 4 is a flowchart of the preferred method of use of the system of FIG. 2;

FIG. 5 is a front view of an alternative embodiment of the system of FIG. 2;

FIG. 6 is a simplified schematic of the alarm device of FIG. 5; and

FIG. 7 is a flowchart of the preferred method of use of the system of FIG. 5;

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional anti-loss wallet devices. Specifically, the invention of the present application enables a person to use a wallet as normal with a robust form of theft prevention. This and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

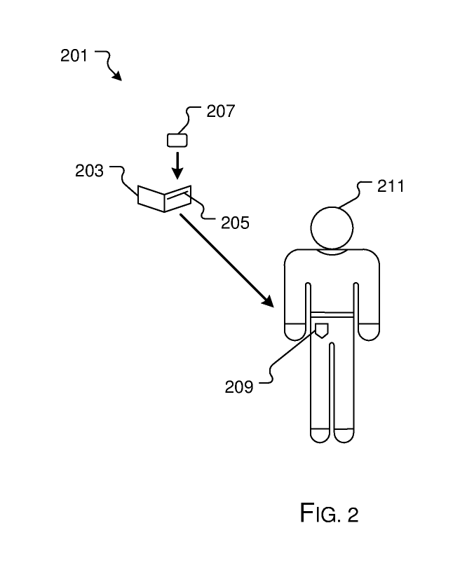

Referring now to the drawings wherein like reference characters identify corresponding or similar elements throughout the several views, FIG. 2 depicts a front view of a property protection system in accordance with a preferred embodiment of the present application. It will be appreciated that system 201 overcomes one or more of the above-listed problems commonly associated with conventional anti-loss wallet devices.

In the contemplated embodiment, system 201 includes a wallet 203 with a slot 205 to hold an alert device 207. The alert device 207 approximating the shape and size of a credit card. Where the wallet is carried on a user's person such has in pocket 209.

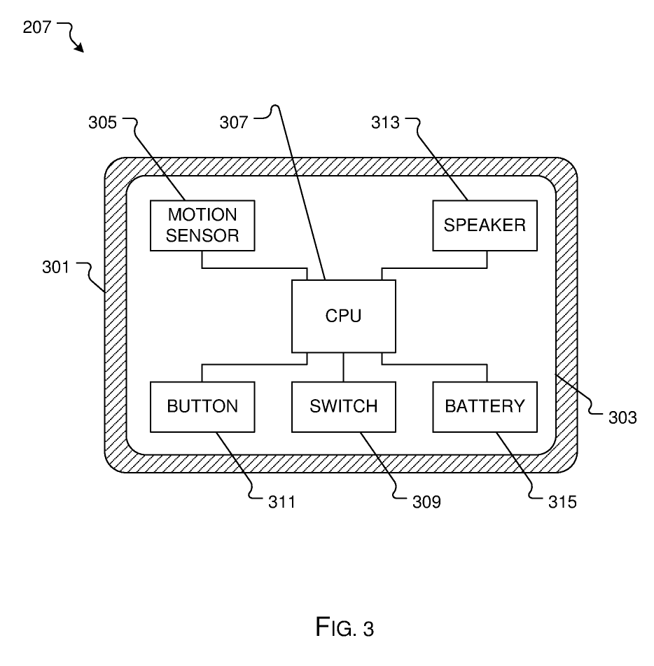

Referring now to FIG. 3 the alert device 207 is depicted including a body 301 that encloses a space 303 where a motion sensor 305 is in electronic communication with a CPU 307. The CPU also in electronic communication with a switch 309, a button 311, speaker 313 and a battery 315.

In use, the alarm device 207 is activated by switch 309. It is then placed in the slot 205 of wallet 203. The wallet is then carried on a user's person in pocket 209. If the motion sensor 305 detects movement outside normal parameters its causes sound to be emitted by speaker 313 unless button 311 is pressed.

It should be appreciated that one of the unique features believed characteristic of the present application is that motion sensor 305 alerts the user to movement of the wallet 203.

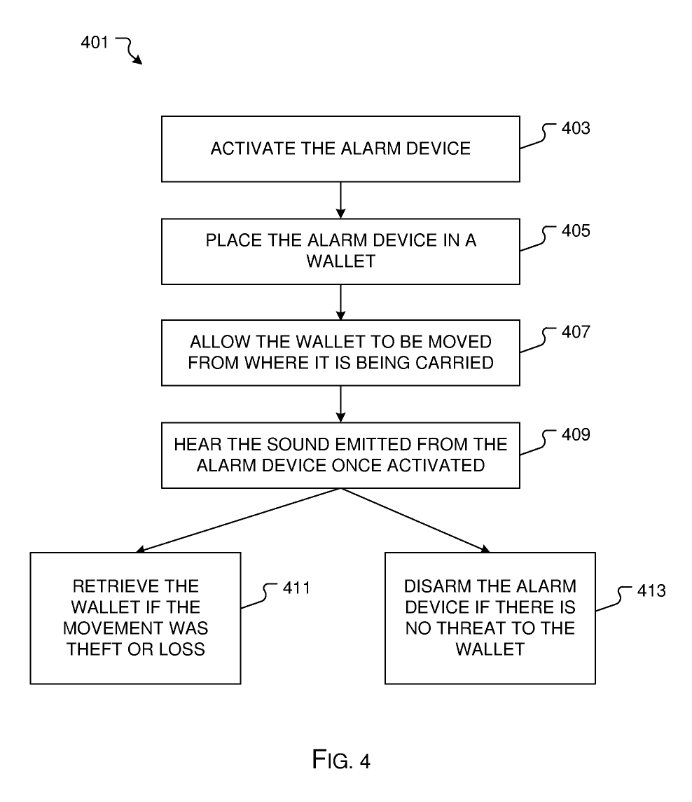

Referring now to FIG. 4 the preferred method of use of the system 201 is depicted. Method 401 including activating the alarm device 403, placing the alarm device in a wallet 405, carrying the wallet normally 405, allowing the wallet to be moved from where it carried 407, hearing the sound emitted from the alarm device upon detection of the movement of the wallet 409 and retrieving the wallet if the movement was theft or loss 411 or disarming the device if there is no threat to the wallet 413.

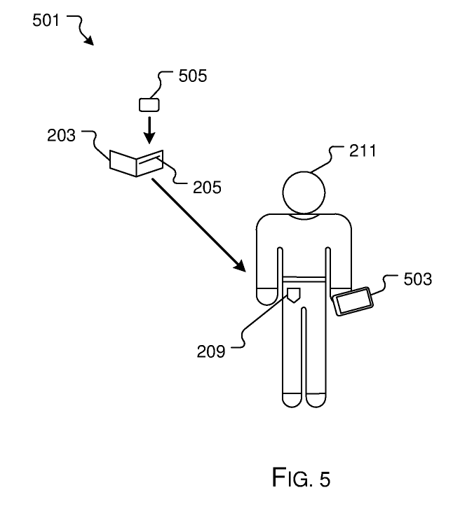

An alternative embodiment of the system 201 is depicted in FIG. 5. Embodiment 501 including similar features as system 201 with the addition of a personal device 503 carried by the user 211. The personal device being in electronic communication with the alarm device 505.

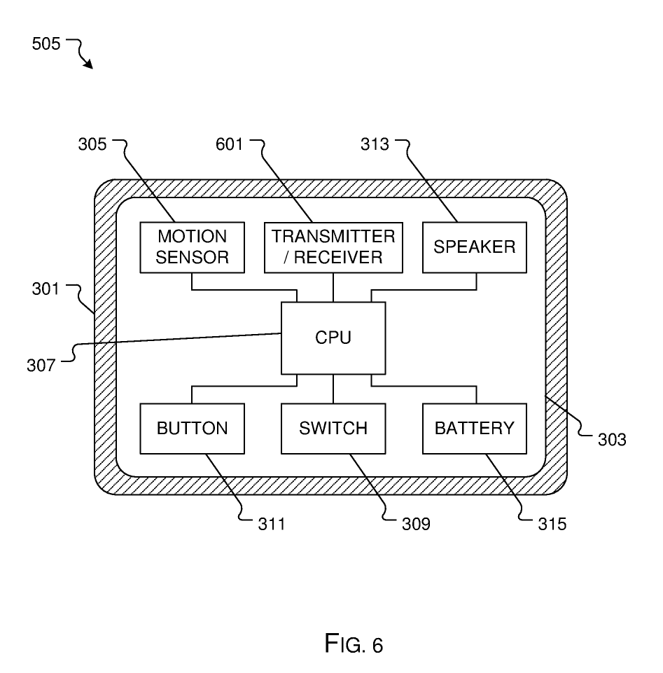

Referring now to FIG. 6 an alternative embodiment of the alarm device 207 is depicted. Embodiment 505 including similar features but with the addition of a transmitter/receiver 601 that allows the device 505 to communicate with the personal device 503.

It will be appreciated that by having the alarm device 505 in communication with the personal device 503 that commands can be sent from the user to the alarm device 505 without removal from the wallet 203. It will also be understood that software applications will be used to interface between the user and personal device 503.

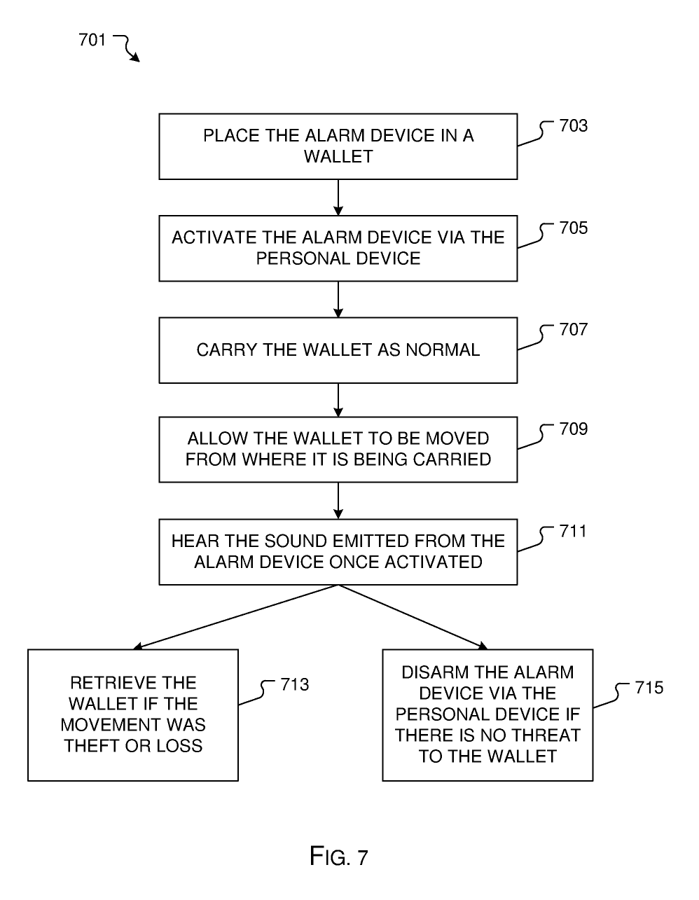

Referring now to FIG. 7 the preferred method of use of the system 501 is depicted. Method 701 including placing the alarm device in the wallet 703, using the personal device to active the alarm device 705, carrying the wallet normally 707, allowing the wallet to be moved from where it carried 709, hearing the sound emitted from the alarm device upon detection of the movement of the wallet 711 and retrieving the wallet if the movement was theft or loss 713 or using the personal device to deactivate the alarm device if there is no threat to the wallet 715.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed;:

1. A property protection system comprising:
an alarm device configured to fit in a slot of a wallet;
the alarm device including at least one body enclosing a compartment;
the compartment configured to hold at least one motion sensor in electronic communication with at least one speaker;
wherein the wallet is carried by a user; and
wherein the motion sensor detects the removal of the wallet and activates the speaker.

2. The alarm device of claim 1, further comprising at least one CPU in electronic communication with the motion sensor and speaker, and where in the CPU is also in electronic communication with at least one switch or button; wherein the switch or button alter the state of the device.

3. The alarm device of claim 1 wherein the motion sensor is in electronic communication with at least one transmitter/receiver, so that the alarm device is placed in electronic communication with a person device; wherein the alarm device is controlled via the personal device.

4. A method of preventing loss of a wallet or other person property given the system of claim 1, comprising:
activating the alarm device;
placing the alarm device in a wallet;
carrying the wallet normally;
allowing the wallet to be moved from where it carried;
hearing the sound emitted from the alarm device upon detection of the movement of the wallet; and
retrieving the wallet if the movement was theft or loss or disarming the device if there is no threat to the wallet.

5. A method of preventing loss of a wallet or other person property given the system of claims 1 and 3, comprising:
placing the alarm device in the wallet;
using the personal device to active the alarm device;
carrying the wallet normally;
allowing the wallet to be moved from where it carried;
hearing the sound emitted from the alarm device upon detection of the movement of the wallet; and
retrieving the wallet if the movement was theft or loss or using the personal device to deactivate the alarm device if there is no threat to the wallet.
